(19) United States
(12) Patent Application Publication
(10) Pub. No.: US 2008/0170596 A1
(43) Pub. Date: Jul. 17, 2008

(54) Method and apparatus for obtaining single longitudinal mode (SLM) radiation from a pulsed Nd:YAG laser

(75) Inventor: Wytze van der Veer, Irvine, CA (US)

Correspondence Address: Daniel L. Dawes;MYERS DAWES ANDRAS & SHERMAN LLP, 19900 MacArthur Blvd., Suite 1150, Irvine, CA, 92612, US

(73) Assignee: The Regents of the University of California, Oakland, CA (US)

(21) Appl. No.: 11/654,873

(22) Filed: Jan. 17, 2007

(51) Int. Cl. H01S 3/13

(52) U.S. Cl. 372/29.011

(57) ABSTRACT

The invention includes a method for seeding and stabilizing an optical device, including a continuous wave laser, a pulsed laser or a parametric system, having an adjustable cavity length and an output. The illustrated embodiment is a Q-switched Nd:Yag or Brilliant A pulsed laser, but the principles of the invention could be literally applied to other types of lasers, including continuous wave lasers and to any parametric optical device whose operation depends in whole or part on the effective optical length of a cavity. The method comprises the steps of seeding the optical device with a seed signal, generating a feedback signal from the output of the optical device; and adjusting the effective optical length of the cavity of the optical device to maintain stable operation of the optical device by means of the feedback signal.

### BACKGROUND OF THE INVENTION

1. Field of the Invention

The invention relates to the field of apparatus and methods for the stabilization of the operation of a laser or another optical device.

2. Description of the Prior Art

Pulsed, Q-switched solid-state lasers are an almost ubiquitous light source for powerful, short laser pulses, as used in industry and research labs. Typically, a simple free running cavity design is employed, while more demanding applications require seeded lasers. In that case a narrow bandwidth beam is introduced into the cavity of the host laser. The wavelength of the continuous wave (CW) laser is adjusted to coincide with the fluorescence maximum of the gain material of the host. When the CW laser is resonant with one of the cavity modes of the host, this mode will win the mode competition for the population inversion in the gain material with regard to the other longitudinal modes present in the free running host laser.

When the host laser is seeded, the bandwidth produced is reduced dramatically. In the case of Nd:YAG, the width of the fluorescence maximum at 1064 nm is ˜20 GHz, while the bandwidth of a seeded Nd:YAG laser with a pulse duration of 8 ns is typically 0.1 GHz, a reduction by a factor of 200. The narrow bandwidth is required for applications in spectroscopy, and for pumping narrow bandwidth optical parametric oscillators (OPO). Similarly the coherence length of these light pulses increases from ˜1.5 cm to 3 meters, which is important for coherent detection schemes, such as coherent Lidar, and CARS.

The seeded lasers also show superior pulse characteristics. In free running Q-switched lasers each pulse is modulated by beating between the longitudinal modes generated in the cavity. Because of the random nature of these modes, each consecutive pulse shows a different shape. The free running modes are built up from the vacuum background, the time required to build up a mode is also subject to random behavior, causing jitter in the timing of the generated pulse.

In seeded lasers the pulse is built up from the injected radiation, eliminating the random behavior. The generated radiation only contains one longitudinal mode and as a result no beating artifacts.

Seeded Nd:yag lasers are currently available from a number of suppliers, such as Continuum (coherent), Spectra physics and Quantel. Most of these are expensive mainframe lasers, e.g. more than $100.000 in 2006. All these lasers are based on the same design as shown in FIGS. 1a and 1b. In these lasers, the Q-switch is formed by a polarizer and a Pockel's cell placed in front of the back reflector of the cavity. The seed-beam is brought into the cavity via the polarizer with the same polarization as the reflected beam. The electronic speed of the Pockel's cell is reduced, increasing the build-up time of the pulse in the oscillator. The timing of the generated pulse is then observed with a photo diode. The rear mirror in the lasers is mounted in a piezo-transducer, and its position is dithered. A lock-in scheme then allows to minimize the build-up time of the oscillator, making the cavity resonant with the seed-beam. The cavity of the host laser is also fitted with two quarter-wave plates, so that the beams traveling either way through the cavity have opposite circular polarization. In this way, the generation of a second longitudinal mode through spatial hole burning is prevented.

### BRIEF SUMMARY OF THE INVENTION

The illustrated embodiment of the invention is a method for seeding and stabilizing an optical device, including a continuous wave laser, a pulsed laser or a parametric system, having an adjustable cavity length and an output. The illustrated embodiment is a Q-switched Nd:Yag or Brilliant A pulsed laser, but the principles of the invention could be literally applied to other types of lasers, including continuous wave lasers and to any parametric optical device whose operation depends in whole or part on the effective optical length of a cavity. The subject class of devices is hereinafter defined as an “optical device”. The method comprises the steps of seeding the optical device with a seed signal, generating a feedback signal from the output of the optical device; and adjusting the effective optical length of the cavity of the optical device to maintain stable operation of the optical device by means of the feedback signal.

The step of seeding the optical device comprises the step of introducing a seed beam into the cavity of the optical device outside of the cavity of the optical device.

Where the optical device is a Q-switched pulsed laser, the step of seeding the optical device comprises the step of introducing a seed beam into the cavity of the Q-switched pulsed laser outside of the cavity of the Q-switched pulsed laser.

Where the optical device is a Q-switched Nd:Yag laser, the step of seeding the optical device comprises the step of introducing a seed beam into the cavity of the Q-switched Nd:Yag laser outside of the cavity of the Q-switched Nd:Yag laser.

The step of seeding the optical device comprises the step of introducing a seed beam into the cavity of the optical device by means of a tunable source.

The step of adjusting the optical length of the cavity of the optical device to maintain stable operation of the optical device comprises the step of dithering the wavelength of the tunable source to maintain stable operation.

The step of adjusting the optical length of the cavity of the optical device to maintain stable operation of the optical device comprises the step of adjusting the physical length of the cavity to maintain stable operation.

The step of introducing a seed beam into the cavity of the optical device outside of the cavity of the optical device comprises the step of introducing a seed beam into the cavity of the optical device by means of a polarizer in front of the cavity of the optical device.

The step of generating a feedback signal from the output of the optical device comprises the steps of detecting signals associated with the envelope of the optical pulses produced by the optical device; and matching the cavity length of the optical device to the seed signal by use of the detected signals.

More specifically, in the illustrated embodiment the step of generating a feedback signal from the output of the optical device comprises the steps of detecting signals associated with the envelope of the optical pulses produced by the optical device; generating independent signals for the pulse intensity of the optical pulses and an RF modulation of the optical pulses from the detected signals; generating the feedback signal to minimize the RF modulation of the optical pulses; and matching the cavity length of the optical device to the seed signal by use of the feedback signal.

In one embodiment the step of adjusting the physical length of the cavity to maintain stable operation comprises driving a piezo with the feedback signal. The step of generating a feedback signal from the output of the optical device comprises the step of generating the feedback signal completely within a computer to observe an average piezo drive voltage to monitor when the piezo reaches its end range of motion and to restart a lock loop control to adjust the physical length of the cavity.

In another embodiment the method further comprises operating an optical shutter, which is only opened when stable seeding is achieved and is closed whenever a rise in the feedback signal is observed indicative of a rise in RF modulation.

In still a further embodiment the method further comprises pumping a single longitudinal mode (SLM) optical parametric oscillator (OPO) by the optical device.

The invention expressly includes within its scope an apparatus in which any one of the above methods are performed. As stated above the illustrated embodiments are a Q-switched Nd:Yag or Brilliant A pulsed laser, but the principles of the invention can literally be applied to other types of lasers, including continuous wave lasers and to any parametric optical device whose structure or operation depends in whole or part on the effective optical length of a cavity, or to a system and combination of devices in which at least one of the components of the system or combination has in whole or part a variable effective optical cavity length.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIGS. 1a-1c are block diagrams of the general layout of two prior art nano-second Nd:YAG lasers and the illustrated embodiment of the nano-second Nd:YAG laser of the invention. FIG. 1a is a block diagram of a prior art free running design. FIG. 1b is a block diagram of a prior art seeded design. FIG. 1c is a block diagram of the layout used in the illustrated embodiment of the invention.

FIG. 2 is a photograph of a burn profile of the beam from Nd:Yag laser rejected by polarizer P₂ of FIG. 1c in front of aperture A₁. The outer diameter of this ring is 8 mm. The aperture removes the ring, while the seed-light enters through a 2.5 mm hole in the center (dotted circle).

FIG. 3 is a block diagram of the layout of the seed-laser with optics to suppress reverse radiation from the host laser.

FIG. 4 is a functional block diagram of the electronic circuit used for the initial proof of concept for generating the feedback signal.

FIG. 5 is a graph of the signals obtained with the initial RF demodulation circuit of FIG. 4 and a Continuum Powerlite 8000 laser taken with different filters.

FIG. 6 is a detailed schematic of the circuit designed to detect the pulse intensity and RF signals of the laser pulse.

FIG. 7 is a detailed schematic of a high voltage driver circuit for the piezo-electric transducer.

FIG. 8 is a graph of the temporal profile of the laser pulses, recorded with a 2 GHz photo diode and a Tektronix TDS680C), GHz oscilloscope. When seeded the pulses are smooth and show <1 ns jitter. When not seeded the cavity build-up time is 33 ns longer and the pulses show strong modulation due to beating between the cavity modes.

FIG. 9 is a graph of the fringe pattern of the seeded nanosecond laser (1064 nm), with a Fabry-Perot scanning etalon. The free spectral range of the etalon is 1.5 GHz, Finesse 150 (10 MHz resolution). The observed bandwidth is 158 MHz. The pulse duration is 5.6 ns (See FIG. 7). The Fourier product ΔvΔt is 158 10⁶×5.6 10⁻⁹=0.88.

FIG. 10 is a graph of the spectrum of the seeded, free running Nd:Yag laser (2 recordings). A 1 m spectrometer was fitted with a Pixelink PL A661 camera. The exit slit was opened completely and imaged with a 4× microscope objective on the CMOS chip. In the free running mode a random, broad spectrum is generated. When seeded the spectral distribution clearly narrows.

FIG. 11 is a graph of the feedback signals recorded when scanning the length of the optical cavity. The pulse intensity remains stable, while the RF modulation of the pulse shows strong modulation. In the feedback software the compensated signal; the RF intensity divided by the pulse intensity is used. The visibility of this signal is more than 170.

FIG. 12 is a graph of the voltage on piezo and the correction of this voltage, shown for time span of almost three hours. On this graph t=0 is 30 minutes after making a cold start. It is expected that the seed-loop can remain stable for considerably longer times.

FIG. 13 is a block diagram of a seeded Brilliant A laser.

FIG. 14a is a photograph of the burn marks of the output beam of the laser of FIG. 13 (back burn). FIG. 14b is a photograph of the vertically polarized component of this beam, which is rejected by the polarizer P2. FIG. 14c is a photograph of a burn mark of the radiation passing through the aperture placed behind polarizer P2. The aperture is optimized to only transmit a 1.5 mm diameter central area of this beam.

FIG. 15 is a graph of the temporal profile of the pulses produced at full power, seeded and unseeded. The pulses do show a “square” shape, while the shape of the unseeded pulses is modulated as well. The shift in timing between the seeded and un-seeded pulses is only 3.2 ns.

FIG. 16 is a graph similar to FIG. 15 except the gain in the laser was reduced by increasing the delay of the Q-switch to 250 μs. The pulsed show a more Gaussian shape, but the time-shift of the pulses due to seeding remains small at 4.5 ns.

FIG. 17 is a graph of the spectrum of the seeded and the free running Nd:Yag laser (2 recordings). The seed laser was also re-tuned to assure a better spectral overlap between the seed and host lasers.

FIG. 18 is a graph of the pulse duration (FWHM) and bandwith obtained from the FWHM of etalon fringes. As the Q-switch delay of this laser is increased, the optical gain in the cavity is reduced and the duration of the produced pulses becomes longer. Seeding the longer pulsed results in a narrower bandwidth.

FIG. 19 is a graph of the pulse energy verses Q-switch delay and time-bandwidth product, obtained from the data shown in FIG. 18. When the Q-switch delay is increased the pulse-power is reduced. Also, at delays above 250 ps the TBW product deteriorates from 0.8 at full power to 1. 3 at a delay setting of 290 μs.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

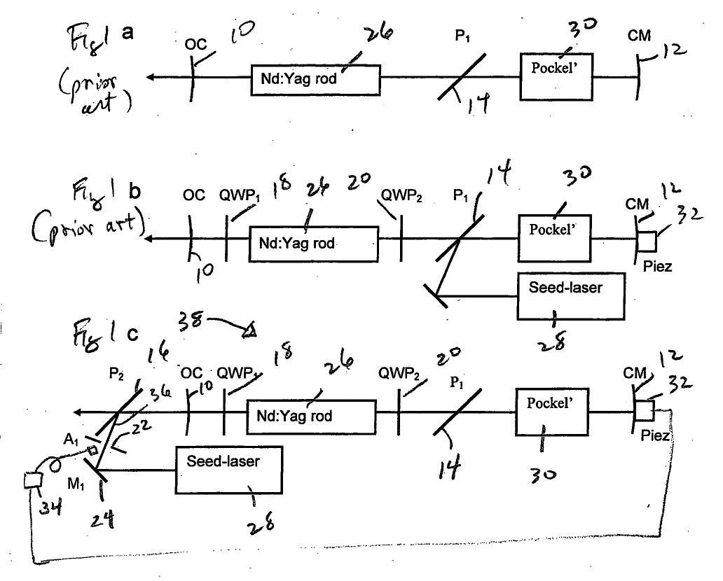

Consider the seeding of small frame Nd:Yag lasers. We set out to make the seeding technique applicable to small, relatively inexpensive Q-switched Nd:YAG lasers. It is not practical in small Q-switched Nd:YAG lasers to introduce the seed-beam via the polarizer into the laser cavity, because of space constraints. Also, modifying the driver electronics of the Q-switch, to reduce its speed, is not desirable. Instead in the illustrated embodiment the seed-beam is introduced into the cavity via a polarizer mounted directly in front of the laser as shown in FIG. 1c. In FIGS. 1a-1c the element OC 10 is an output coupler or Gaussian dot mirror. CM 12 is a cavity mirror. In seeded lasers the cavity length is adjusted with a piezo-electric actuator 32 coupled to cavity mirror 12. P₁14 and P₂ 16 are thin film polarizers. QWP₁ 18 and QWP₂ 20 are quarter wave plates. A₁ 22 is an aperture made in Teflon sheet material which in the illustrated embodiment has a diameter of 2.5 mm. M₁ 24 is a dielectric mirror. Each laser in FIGS. 1a-1c includes a Nd: Yag rod 26 and a Pockel's cell 30. The embodiments of FIGS. 1b and 1c also include a seed laser 28.

The disclosed feedback system uses the observation of modulation of the intensity of the produced optical pulse. When the laser is seeded, and the light pulse is observed with a photo detector 34, only relatively low frequency signals are generated, which are associated with the envelope of the pulse. For an 8 ns pulse these signals typically lie below 125 MHz. When the laser is not seeded, a large number of longitudinal modes are produced, and the beating between these modes is observed as a modulation on the intensity of the laser pulse. For lasers with a cavity shorter than 0.5 meter, these beat signals have a frequency of more than 300 MHz. Using a suitable electronic filter, these two components of the detected intensity profile can be separated, and used to generate independent signals for the pulse intensity and an RF signal. The feedback mechanism for matching the cavity length to the seed minimizes the RF modulation of the generated pulse.

In FIG. 1c coupling the seed-beam 36 in through the exit port of the host laser, generally denoted by reference numeral 38, and the RF detection technique, eliminate the need for the two major modifications to the host laser 38. However, it is still necessary to mount a quarter wave plate 18, 20 on either side of the gain medium or rod 26 and to mount one of the cavity mirrors, e.g. mirror 12, on a piezo-electric actuator 32. In most commercial laser systems these modifications are relatively easy.

Turn now and consider the host laser 38. For the experiments in the illustrated embodiment we modified a commercial small frame Nd:YAG laser, (Ekspla NL302). The frame of this laser is an elongated aluminum box. The cavity mirror 12 and the output coupler 10 are placed on the far ends of the box, while the Pockel's cell 30, polarizer 14 and the lamp-pumped Nd:YAG amplifier or rod 26 are placed inside the box. The rear or cavity mirror 12 was placed on a piezo-electric ring actuator 32. The movement of the actuator 32 is specified as 15 μm at a drive voltage of 1 kV.

A thin film polarizer P₂ 16 was placed in front of the laser 38 to direct the seed-beam 36 into the laser cavity. Brackets mounted onto the frame, holding the quarter wave plates 18, 20 were placed on either side of the Nd:Yag amplifier or rod 26. The wave plates were aligned using the beam of the seed-laser. A mirror was placed behind the front quarter wave plate QWP₁ 18. Observing the reflected beam via polarizer P₂ 16, the wave plate 18 was rotated to minimize the reflection with the same polarization as the incident seed-beam 36. Next, QWP₂ 20 is placed in the cavity and the orientation is adjusted for minimum transmission of the seed-beam 36 through the polarizer, P₁16 inside the cavity. In our case, introducing the waveplates 18, 20 into the cavity changed the polarization of the nano-second pulses generated from vertical to horizontal, but in practice any plane of polarization can be equivalently chosen.

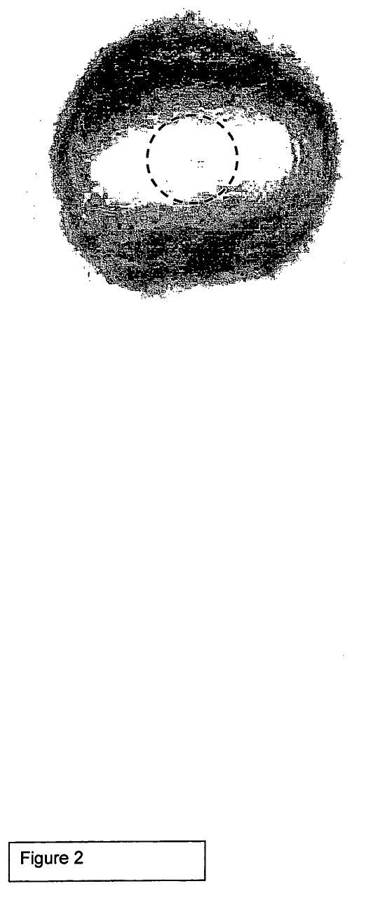

When the laser 38 is fired, the generated beam is not perfectly linearly polarized, a perpendicular component is also present due to depolarization effects in the Nd:YAG rod 26 caused by thermal strain. The temperature gradient is largest close to the side surface of the rod 26, causing the beam rejected by P₂ 16 to look like a ring as shown in the photograph of FIG. 2. An aperture 22 with a diameter of 2.5 mm in a Teflon® sheet was placed behind P₂ 16 to reject this ring while allowing the introduction of the seed-beam 36. A small part of the light scattered from the aperture 22 is coupled into an optical fiber and used for the feedback mechanism, which locks the cavity length to the seed-laser 28.

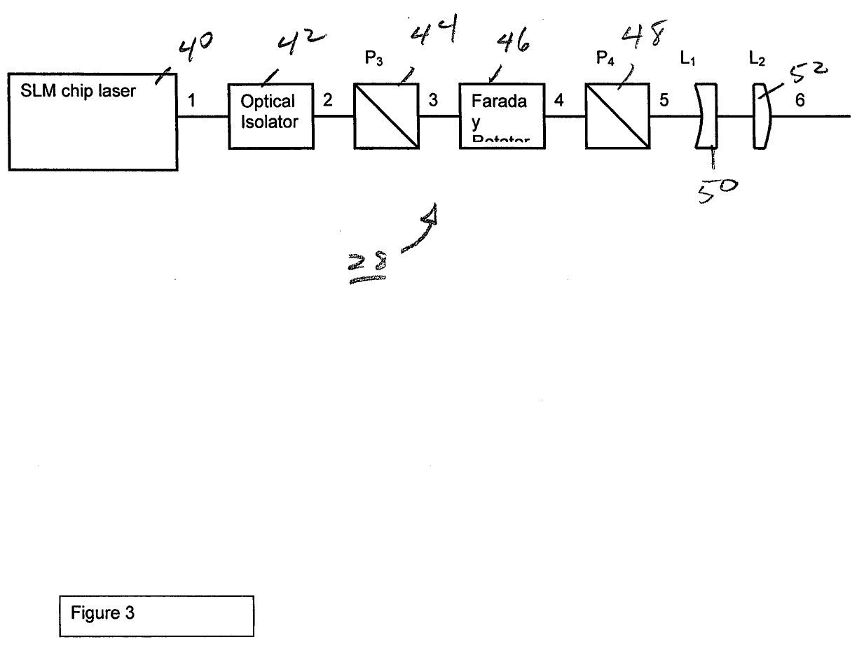

Turn now and consider the seed-laser 38 in greater detail. A Nd:YVO₄ (Vanadate) single longitudinal mode micro chip laser 40 obtained from Elforlight, UK was used as the seed-source in laser 28 as diagrammatically shown in the block diagram of FIG. 3. The optical isolator 42 is 2BIG-1064 (Electro Optics Technology Inc.). P₃ 44 and P₄ 48 are Calcite Glenn-Taylor Polarizers. The Faraday rotator 46 is 2BIG-1064 ROT (Electro Optics Technology Inc.). Lenses L₁ (f=−100 mm) 50 and L₂ (f=150 mm) 52 form a telescope. Behind the telescope the beam diameter is 1.0 mm (1/e). Most of the optics are not Ar coated, causing a substantial loss of power. The power levels at the numbered positions in FIG. 3 are: 1) 57 mW, 2) 40 mW, 3) 33 mW, 4) 27 mW, 5) 20 mW and 6) 18 mW.

The wavelength of this laser 40 is adjusted via the temperature of the chip, which modifies the optical length of the cavity. Using a 1 meter Chromatix spectrometer, mounted with a Pixelink CMOS camera, the wavelength was set to the center of the spectral profile of the free running Nd:Yag laser 38. Single mode operation of the laser 40 was assured using a 1.5 GHz Fabry-Perot interferometer, constructed in our lab. Although the CW laser 40 was rated for 100 mW, the output power was reduced to 57 mW and at higher power levels a parasitic mode appeared ˜2.5 GHz from the main mode. The beam produced by laser 40 is vertically polarized.

The beam 36 was led through a small (7 mm long, 7 mm outer diameter) optical isolator 42. The optically active material is bismuth iron garnet (BIG), and the polarizers in isolator 42 are made of Polarcor, a trademark of Corning. The extinction of this isolator 42 is 37 dB. Next, the beam is brought into a second isolator 46 comprised of a Faraday rotator similar to the one used in the first isolator 42, with two calcite Glenn-Taylor polarizers, P₃ 44 and P₄48, one on either side. The Faraday rotator 46 is oriented so that it compensates for the rotation of the polarization of the first isolator 42. The orientation of the polarizers 44, 48 is adjusted for optimal isolation and maximum transmission of the seed-beam 36, while minimizing the counter-propagating beam. In this embodiment two polarizers P₃ 44 and a Polarcor polarizer inside the first optical isolator 42 are placed behind each other. In principle this Polarcor polarizer is not necessary and could be removed. This would however put very stringent requirements on the alignment of the overall system. The diameter of the beam transmitted by the isolators 42 and 46 is adjusted to 1 mm and collimated using two lenses, L₁ 50 and L₂ 52 with focal lengths +150 mm and −100 mm respectively. Finally the beam 36 is directed via mirror M₁ 24, aperture A₁ 22 and polarizer P₂ 16 into the host laser 38.

Turn now to the generation of the feedback signal. We developed the RF demodulation technique to obtain a feedback signal to adjust the cavity length. This ensures that one cavity mode of the host laser 38 remains resonant with the seed-wave 36. The advantages of this technique are that the speed of the driver of the Pockel's cell 30 does not need to be reduced which results in minimum loss of output power, short output pulses, and minimal jitter.

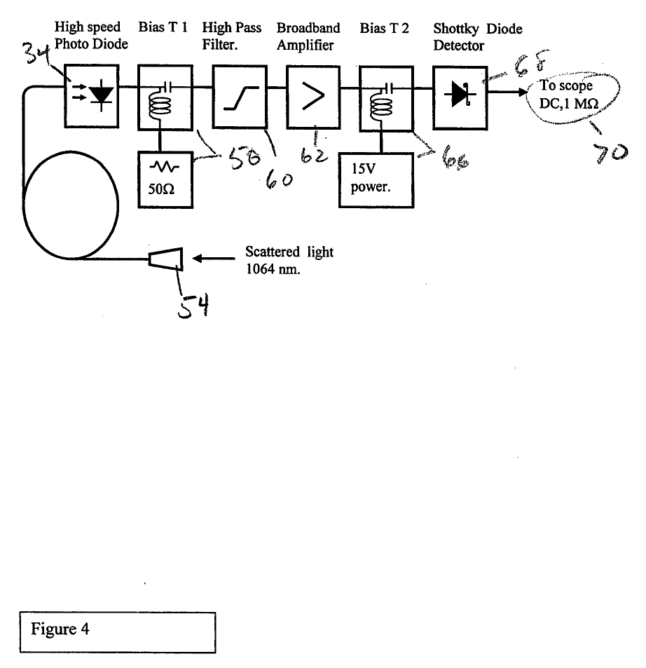

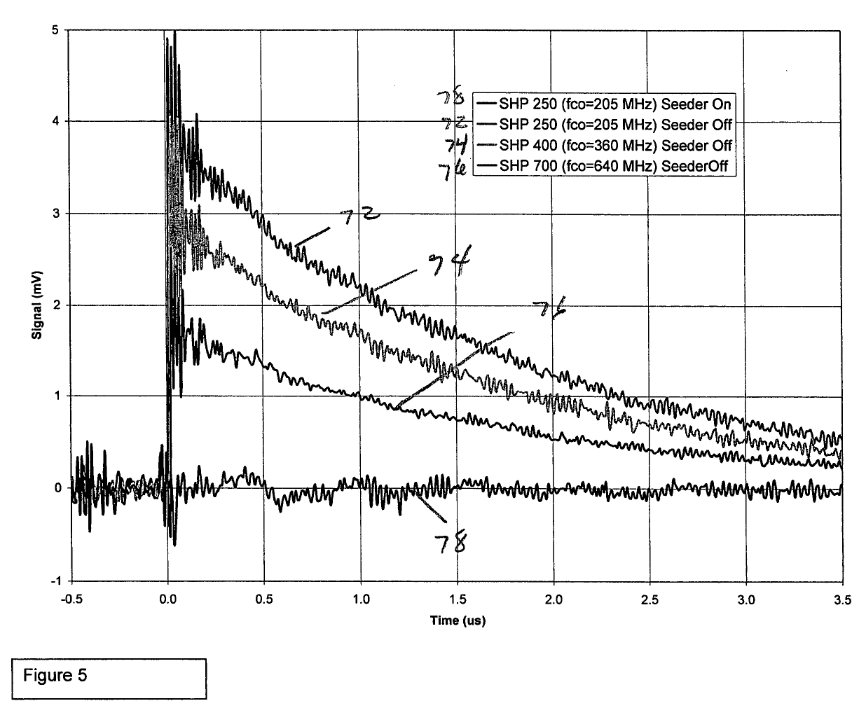

For the first exploratory experiments we used a seeded Continuum PowerLite 8000, Nd:Yag laser 38 and observed scattered light of the fundamental wave, with either the seeder laser 28 on or off. The high frequency component of the signal was detected with the circuit shown in the block diagram of FIG. 4. Fiber coupler 54 is a Thorlabs F220FC-C. Photo diode 34 is a Thorlabs SV2, Silicon with a 2 GHz bandwidth. Bias T's 58 and 66 are Mini-Circuits ZFBT-4R2G, 10-4200 MHz. Filter 60 is one or more of Mini Circuits SHP 250, SHP 400 or SHP 700 with cut-off frequency f_{co} 205, 360 and 640 MHz respectively. Amplifier 62 is a Pasternack PE1510, 18 dB, 500-2000 MHz. Schottky Diode Detector 68 is a Pasternack PE8010, 10-2000 MHz, 500 mV/mW. The scattered light was picked up with a fiber coupler 54 and led into a 2 GHz silicon photo diode detector 34. The diode 34 is terminated at 50 ohms via a bias tee 56. The high frequency component of the photo diode signal is passed through a high pass filter 60. Three different types of filters were used for filter 60, namely Mini Circuits SHP 250, SHP 400 and SHP 700 with cut-off frequencies (f_{co}) of 205, 360 and 640 MHz, respectively. The signal is then amplified by 18 dB with a broadband RF amplifier 62. The power for the amplifier is provided via the second bias tee 66. The amplified signal is demodulated with a 2 GHz Schottky-diode detector 68 and recorded with an oscilloscope 70. The signals, as shown in the graph of FIG. 5, clearly demonstrate the viability of this detection concept. In FIG. 5 the signal in mv is graphed as a function of time in μs. Three filters obtained from Mini Circuits were used: SHP 250 (f_{co}=205 MHz), SHP 400 (f_{co}=360 MHz) and SHP 700 (f_{co}=640 MHz). The mode spacing in this laser is 288 MHz and the pulse duration ˜8 ns. The filter with cut-off frequency 205 MHz is sufficient to separate the RF component. Filters with higher cut-off frequencies lead to the loss of signal. When the seeder was on, identical signals were observed for all filters.

The upper two curves 72 and 74 is the signal when filters SHP 250 and SHP 400 respectively were used when the seeder is off, and the lower two curves 76 and 78 is the signal when filters SHP 700 and SHP 250 were used respectively when the seeder is on. When seeded, the detected RF signal practically disappears; the RF signal becomes strong when the laser is not seeded.

The cavity of the Continuum PowerLite laser 38 is relatively large (52 cm) and the beating frequency (f=c/21, c is the speed of light, I is the length of the cavity) is relatively small (288 MHz). It is thus important to choose a filter 60 with a cut off frequency f_{co} below this beating frequency to detect the beating between adjacent cavity modes, but high enough to reject the envelope of the pulse. As can be seen form the measurements of FIG. 5, the filter 60 with cut-off frequency 205 MHz gave the best results, giving the largest detected signal while completely rejecting the pulse envelope. For our next experiments, we used a laser 38 with cavity length of 38 cm, where the lowest beat frequency is 394 MHz and a filter 60 with f_{co} 360 MHz was chosen.

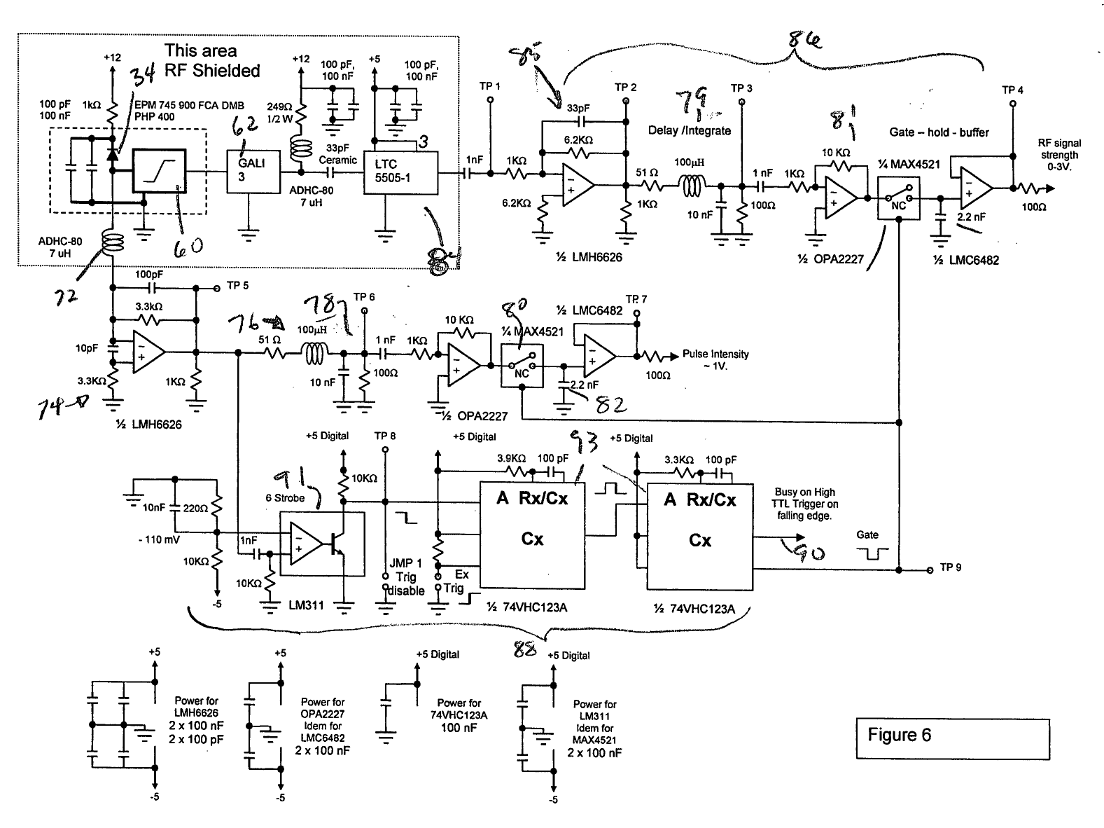

Turn now to a more detailed consideration of the detector circuit. To integrate this detection scheme with the laser 38, we designed an electronic circuit and assembled it an on a 10 by 8 cm board using SMD components according to the schematic in FIG. 6. The optical signal is detected with a fast InGaAs photo diode 34 (EPM745). The high frequency part is separated with filter 60, PHP400, amplified (Gali 3) and detected (LTC 5501-1). The resulting signal is then amplified again by amplifier 85 (½ LMH6626) and directed via a delay line 79 into the sample-and-hold circuit 81 (½ OPA 2227, ¼ MAX4521, ½ LMC6482). The low frequency part of the detected signal is recovered with a trans-impedance amplifier 74 (½ LMH6626) and directed into an identical delay-line and sample-and-hold circuit 76. The comparator 91 (LM311) and monostable multivibrator 93 (74VHC123) provide the timing signals, GATE, for the sample-and-hold circuits. It is of course to be understood throughout the specification that designation of components and the design in the schematics are by way of example only and does not constitute a limitation of the scope of the invention.

For the illustrated of the embodiment of this circuit we used a high speed, fiber coupled, InGaAs photo-diode 34 with a bandwidth of 3.0 GHz. It is mounted close to the high pass filter 60 to detect the RF component. The low frequency part of the signal is fed via a choke 72 into a trans-impedance amplifier 74. The resulting signal is then used to trigger the sample-and-hold electronics 76. The pulse signal is also led via a delay line 78, into an analog switch 80 with a hold capacitor 82, which acts as the sample-and-hold circuit 76. The timing of the switch coincides with the moment the pulse from the delay line 78 reaches its maximum amplitude.

The RF component of the signal is amplified with a broadband amplifier 62 (Gali 3 from Mini Circuits) and detected with a RF power detector 84 with a buffered output (LTC 5505-1). The resulting signal is then amplified and led into a sample-and-hold circuit 86, similar to sample-and-hold circuit 76 used for holding the pulse signal. The timing circuit 88 also generates a “busy” signal 90, which is used to trigger the data acquisition to read in the RF and Pulse intensity signals.

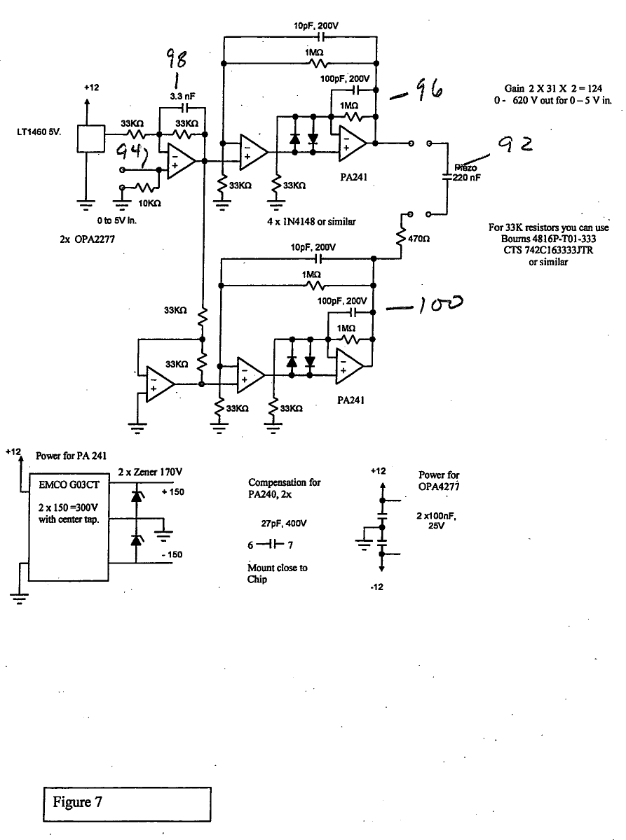

Turn now and consider the piezo circuit 32 shown in block diagram in FIG. 7. The voltage to the piezo-electric element 92 is generated with a high-voltage amplifier 96, which in its turn is driven from a small analog voltage. The input voltage 94, between 0 and 5V is translated into a voltage between −5 V and +5 V with a level converter circuit 98 ( 1/2 OPA2277). The resulting voltage is then amplified by a factor 31 with a high-voltage op-amp circuit 96 (PA241 and ½ PA2277). The steer voltage is also inverted (½ OPA2277) and amplified with a second high voltage amplifier 100, resulting in two high voltage outputs with opposite polarity. The piezo-electric element 92 is connected to these outputs, so that the voltage over the piezo swings over twice the total supply voltage, in this case 600V. The total voltage swing over the piezo 92 is 600V and with this driver is ˜9 μm.

Turn now to the locking mechanism. In our experimental setup, the feedback to lock a mode of the host cavity to the wavelength of the seed-laser 28 is generated by a LabView program. The analog signals are sent to a DAQPad-6020E (National Instruments) interface (not shown), the data acquisition is hardware-triggered by the falling edge of the “busy” signal 90. Similarly, the analog signal 94 which controls the position of the piezo-electric transducer 92, is generated with a second NI DAQPad-6020E unit (not shown).

The LabView program can be run in two modes: sawtooth generation or locking. In the sawtooth mode the position of the piezo 92 is linearly scanned, and at the end of the scan the piezo 92 is gently brought back to its start position. In the lock mode, the piezo 92 is dithered and the ratio of the RF and the pulse signals is recorded. From the difference between the dither-up and dither-down signals, a correction of the average voltage sent to the piezo-driver described in FIG. 7 is calculated.

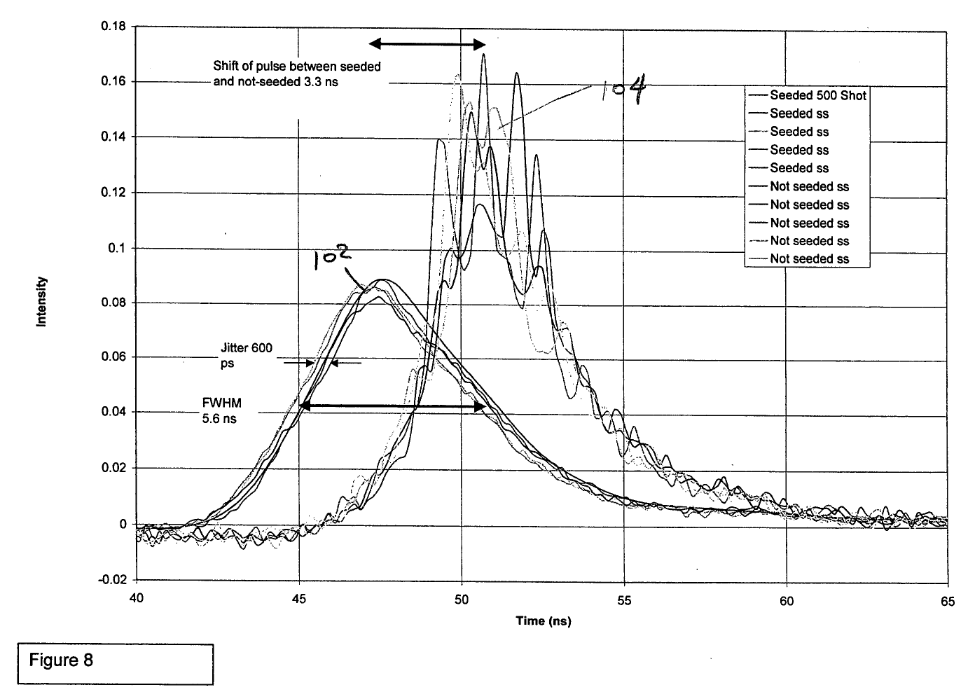

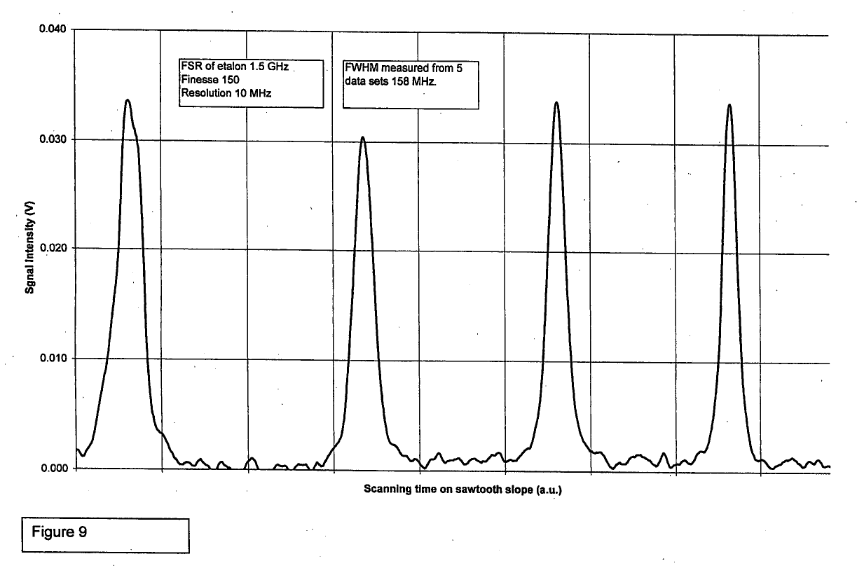

Consider now the operation of the illustrated embodiment and its results. The laser system 38 and seeder system 28 were assembled on an optical breadboard, which proved to be sufficiently stable. The temporal profile of the generated pulses was recorded with a high speed silicon photodiode (Thorlabs SV2) and a 1 GHz Oscilloscope (Tektronix TDS 680C). The oscilloscope was triggered from the same TTL signal that also fires the Pockel's cell 30 in the host laser 38. The results are shown in the graph of FIG. 8 the intensity of the signal is shown as a function of time. As graphed, smooth optical pulses 102 with duration of 5.6 ns (FWHM) are produced when the laser 38 is seeded. When the laser 38 is free running, the laser pulse 104 is delayed by 3.3 ns, and shows strong modulation artifacts due to the beating between the cavity modes. The spectrum of both the seeded and the free-running laser were observed with a 1 meter Chromatix spectrometer. The image plane of the spectrometer is re-imaged with a 4× microscope objective onto a Pixelink PL-A661 CMOS camera with its infra-red absorption filter removed. The image is converted into a spectrum by vertical binning. The recorded spectra are shown in the graph of FIG. 9, showing the spectral narrowing of the seeded radiation.

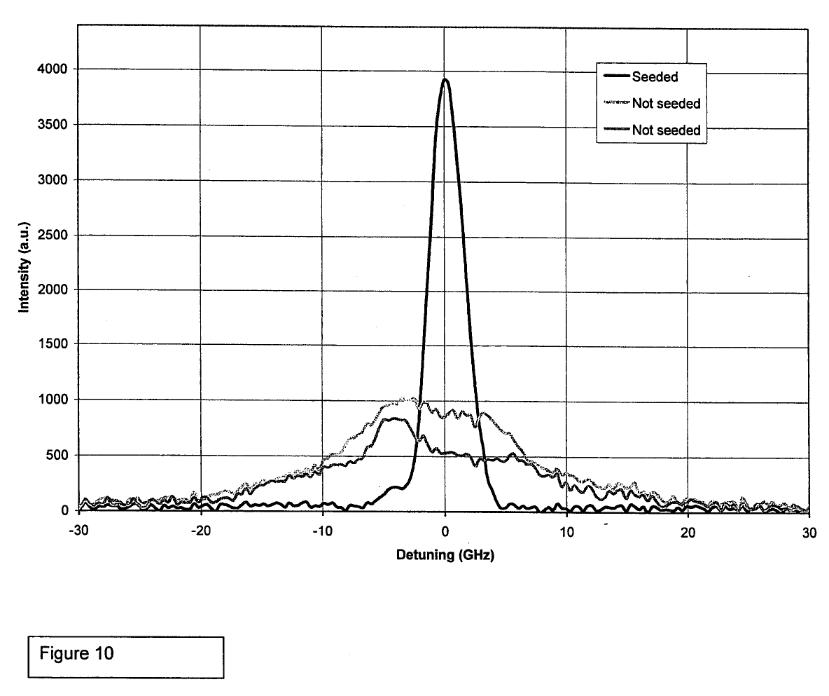

To obtain a higher resolution measurement of the spectral profile of the generated radiation, the bandwidth was measured with a Fabry-Perot interferometer. The finesse of this etalon is 150 and the free spectral range is 1.5 GHz. Therefore, the resolution is 10 MHz, amply sufficient for the measurements described here. A small fraction of the radiation from the seeded laser was passed through this interferometer and recorded. One of the measurements of the seeded and unseeded pulses is shown in the graph of FIG. 10. The average bandwidth obtained from five sets of measurements is 158 MHz. The laser 38 was also operated at a lower power level, by increasing the delay of the Q-switch from 225 μs (optimal) to 312 μs. In this case the pulse duration increased to 9.0 ns. The observed bandwidth is then 82 MHz.

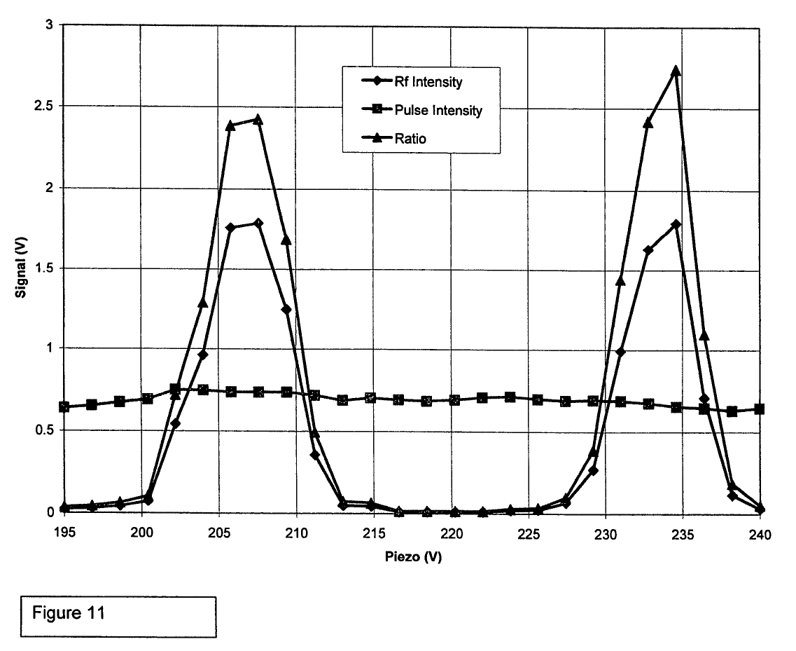

The quality of the generated feedback signal is best observed by scanning the cavity length while recording the feedback signals. These are shown in the graph of FIG. 11 where the RF and pulse intensities are shown with their ratio as a function of time. The resolution of the obtained signal is very good: the ratio between the minimum and maximum signals is more than 170. By observing this signal, the feed back loop attempts to maintain the laser cavity length adjusted to the minimum of this pattern, to correspond to the performance in the graph of FIG. 11 this would require about 220V applied to the piezo 92.

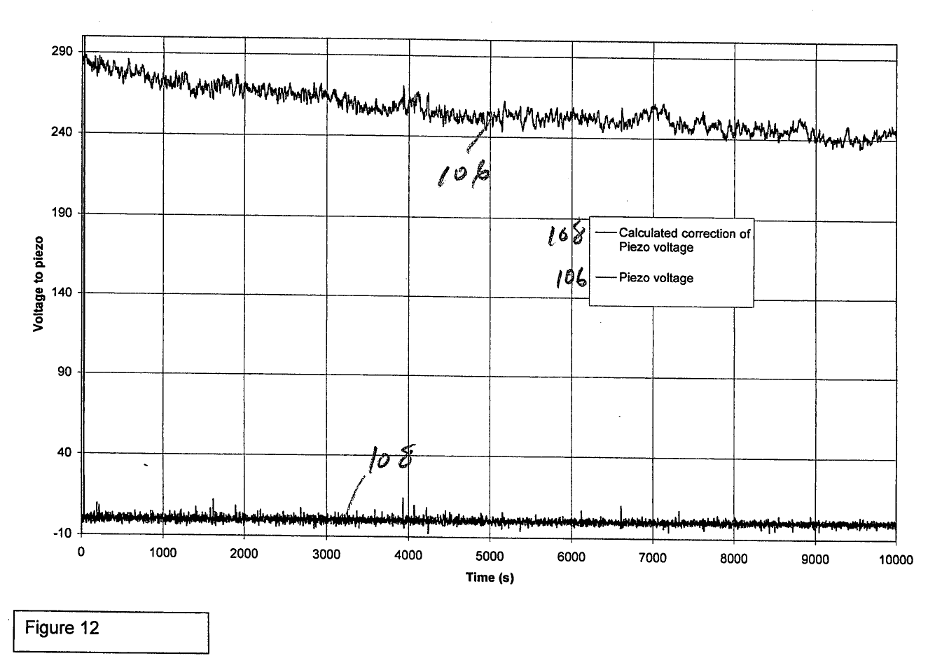

When the seeded laser system 38 is started from “cold”, typically a 30 minute warm-up period is required. If the lock loop is started too soon, the temperature of the laser is still increasing and the cavity expanding. In this case the total movement of the piezo 92 is not sufficient to compensate for this expansion, and the lock is lost. Once warmed up, we are routinely able to keep the laser 38 locked as long as desired, typically a few hours. By observing piezo signal 106 and correction signal 108 over an extended period as depicted in the graph of FIG. 12, it is expected that this lock can be maintained for a considerably longer period.

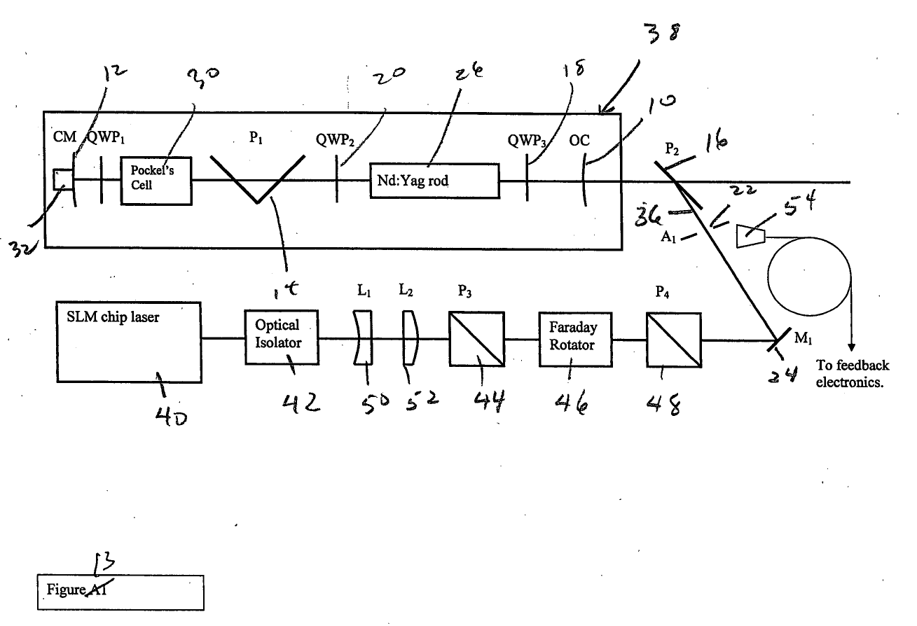

Similar to the apparatus and method described above, a Quantel Brilliant A laser 38 was seeded using the same principles as depicted in the block diagram of FIG. 13. The quarter wave plates QWP2 and QWP3 18, 20 were added to the cavity and the cavity mirror CM 12 was mounted on a piezo-transducer. In this design the polarizer P1 14 is comprised of two consecutive thin film polarizers mounted in a “V” arrangement. The seed beam 36 is coupled in via P2 16. The SLM chip laser 40 is protected with two optical isolators 42, (EOT 2BIG1064 and P3 44, P4 46, placed around a Faraday rotator 46 obtained from Isowave). The beam expansion telescope 50, 52 of the seed-laser 40 was placed between the isolators 42, 46, so that the pulsed radiation reaching the first polarizer 44 does not travel through any converging optical elements.

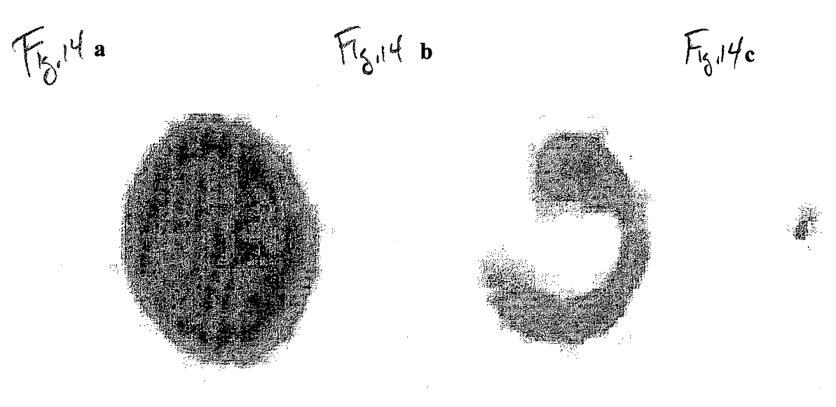

The rear mirror 12 was placed on a piezo electric element 92 (PI Ceramics P-016.00H). The cavity was again fitted with two quarter-wave plates 18, 20, which were in this case mounted on the covers that prove access to the surface of the Nd:Yag rod 26 in the laser 38. The seed beam 36 was coupled into the laser via a polarizer P₂ 16 placed in front of the laser 38. The cavity of the laser 38 was aligned to make the depolarized fraction of the pulsed beam, which is rejected by this polarizer 16, as symmetric as possible as shown in the photographs of FIGS. 14a-14c. The laser 38 was again seeded, and a stable lock could typically maintained as long as needed, typically several hours at least.

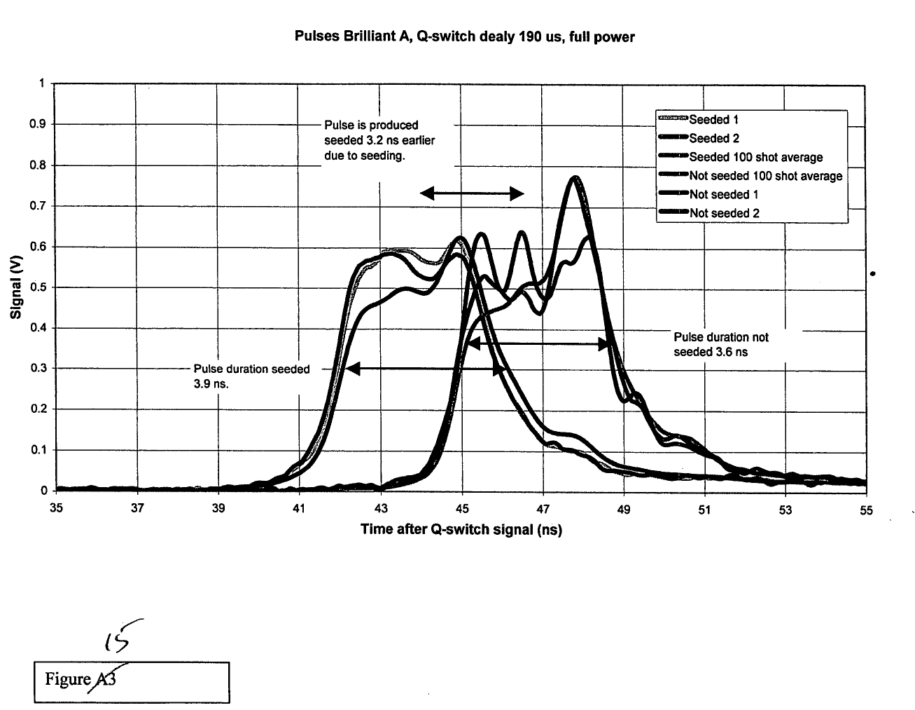

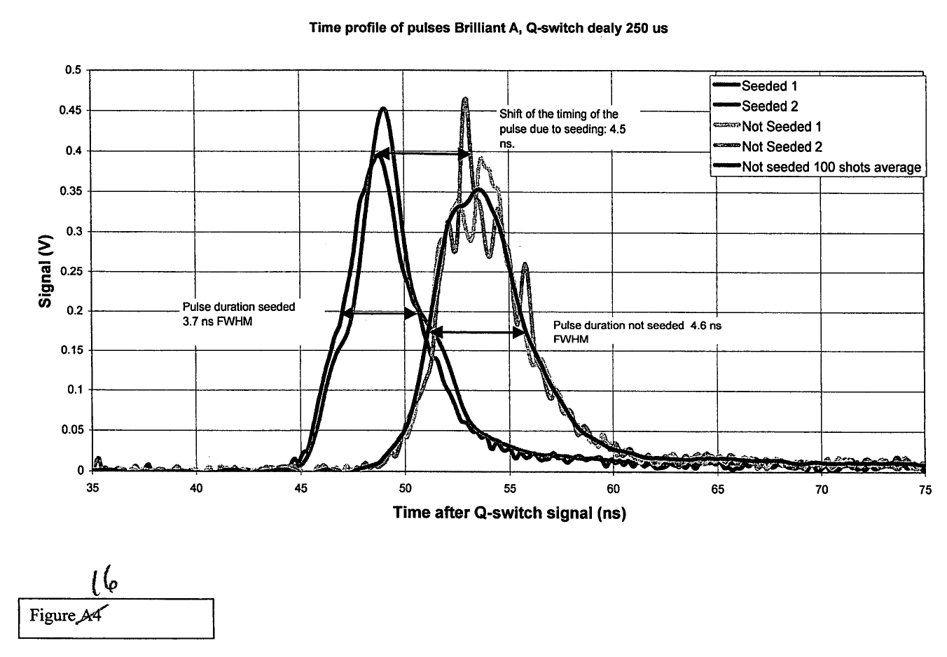

As can be seen from the oscilloscope traces shown in the graphs of FIG. 15 and FIG. 16, seeding the laser 38 removes the modulation of the generated laser pulse as before. When the host laser 38 is seeded, the oscillation builds up faster, but the difference in timing is in the order of the duration of the laser pulse itself. It would be hard to use this small timing effect for a stabilization mechanism, demonstrating the benefit of the stabilization technique described here.

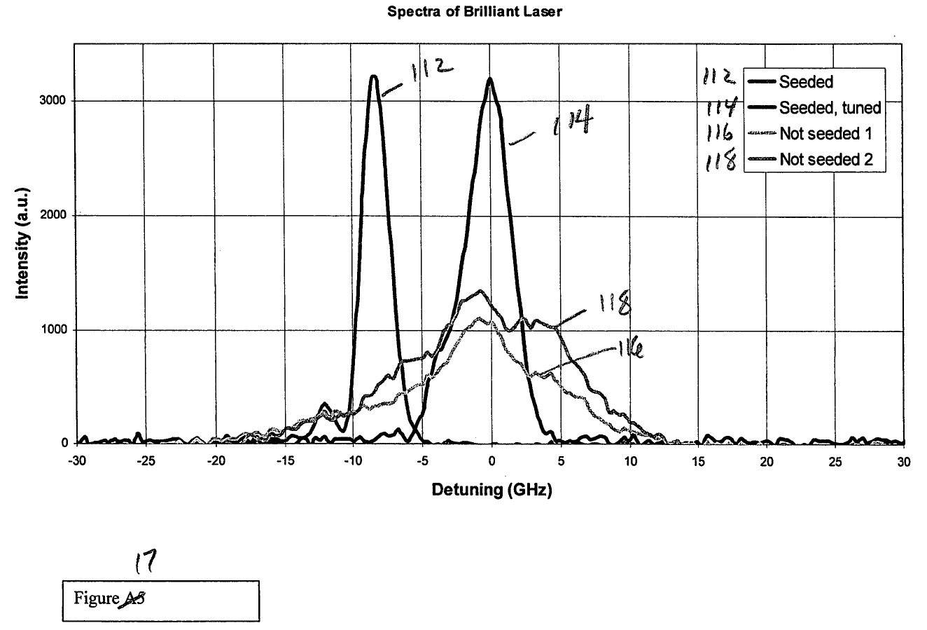

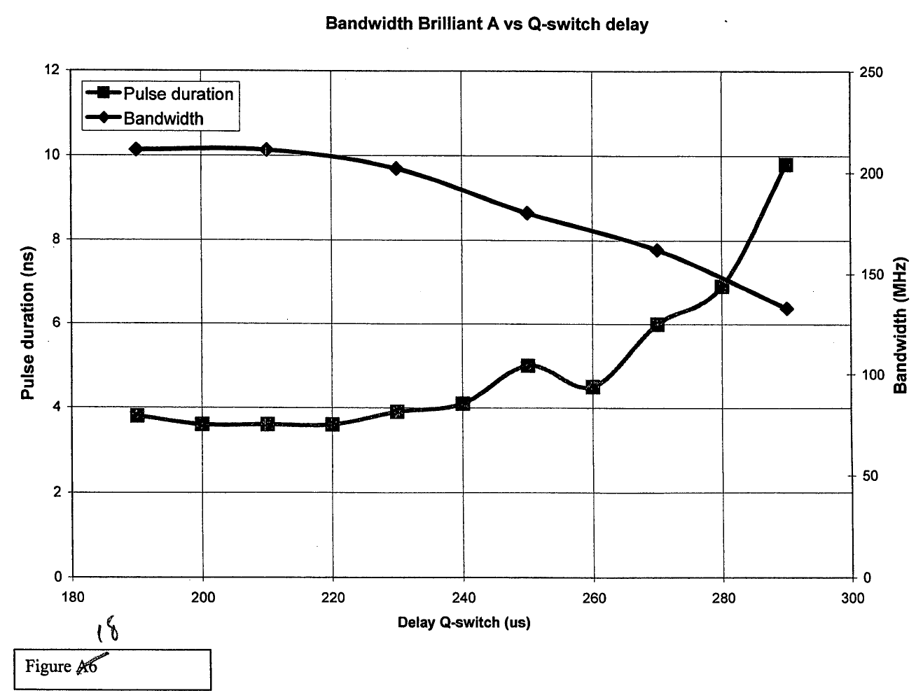

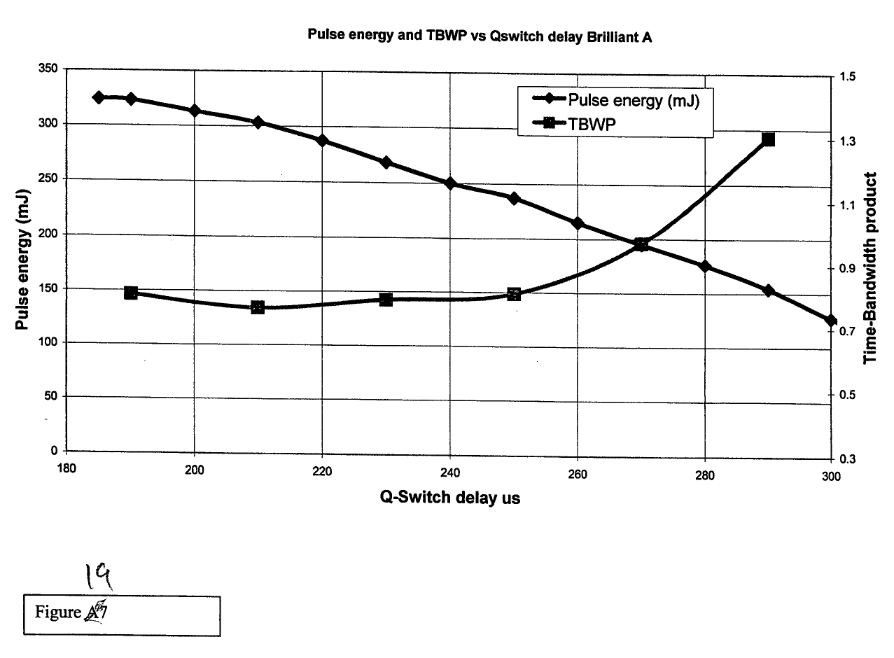

When the laser 38 is seeded, the optical bandwidth of the produced radiation is dramatically reduced. In the graph of FIG. 17 spectra are shown of the pulsed radiation with seeding on and off. A 1 m spectrometer was fitted with a Pixelink PL A661 camera. The exit slit was opened completely and imaged with a 4× microscope objective on the CMOS chip. In the free running mode a random, broad spectrum is generated. When seeded the spectral distribution clearly narrows. The bump on the left side of the seeded peaks is an instrumental artifact. The recorded bandwidth of the seeded radiation is in this case limited by the instrument; a 1-meter spectrometer fitted with a CCD camera. Similar to that described above, the bandwidth of the generated radiation was recorded using a 1.5 GHz etalon. The bandwidth was measured for various delay times of the Q-switch. At a longer delay time the effective gain in the host laser 38 will be lower which causes the generated pulses to become longer. Ideally the bandwidth of the laser 38 should be reduced accordingly. As can be seen in the graphs of FIGS. 18 and 19 the bandwidth is indeed reduced, but the time bandwidth product does deteriorate from 0.8 at full power to 1.3 at a Q-switch delay setting of 290 μs. At this delay setting the output power is reduced to less than a half.

The measurements presented here show clearly that the Quantel Brilliant A laser can be successfully be seeded using the same principles, bringing in the seed laser via the output port, and using the RF-demodulation technique.

We have demonstrated above a technique for seeding and stabilizing a nanosecond Nd:Yag laser 38. With the current availability of very fast (multiple GHz) electronic components made for telecom applications, a feedback signal can be derived which is superior to the previous locking techniques. This is an improvement to the conventional technique because no modification (slowing down) of the Pockel's cell driver is required. This means that the produced seeded-pulse has ultimate specifications in timing accuracy, and the shortest possible output pulse can be produced.

The feedback signal generated here is a direct spectral observation of the laser pulse. As opposed to the cavity build-up time, the signal is a direct verification of a single longitudinal mode (SLM). The feedback loop is completely computer controlled which allows for the easy observation of the average piezo-voltage, so that the user can be warned when the piezo 92 inadvertently reaches its end and the lock loop may need to be restarted. A second practical feature is that the software can operate an optical shutter, which is only opened when stable seeding is achieved, and closed whenever a rise in the RF feedback signal is observed.

This technique is shown here for a Nd:YAG laser 38, but can similarly be employed for stabilizing the seeding of a large variety of other lasers and parametric systems by using the principles of the illustrated embodiment. A particularly interesting application is the stabilization of a SLM OPO, which could be pumped by this laser.

For many applications a pulse with a large coherence length is required, while the exact wavelength is of less importance. For these applications the seed-laser 28 could be replaced with a tunable source. In that case there will be no need to mount a piezo-electric element 32 in the host-laser 38. Instead the wavelength of the seed-laser 28 could be dithered and continually adjusted.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method for seeding and stabilizing an optical device, including a continuous wave laser, a pulsed laser or a parametric system, having an adjustable cavity length and an output comprising:
seeding the optical device with a seed signal;
generating a feedback signal from the output of the optical device; and
adjusting the optical length of the cavity of the optical device to maintain stable operation of the optical device by means of the feedback signal.

2. The method of claim 1 where seeding the optical device comprises introducing a seed beam into the cavity of the optical device outside of the cavity of the optical device.

3. The method of claim 1 where the optical device is a Q-switched pulsed laser and where seeding the optical device comprises introducing a seed beam into the cavity of the Q-switched pulsed laser outside of the cavity of the Q-switched pulsed laser.

4. The method of claim 1 where the optical device is a Q-switched Nd:Yag laser and where seeding the optical device comprises introducing a seed beam into the cavity of the Q-switched Nd:Yag laser outside of the cavity of the Q-switched Nd:Yag laser.

5. The method of claim 1 where seeding the optical device comprises introducing a seed beam into the cavity of the optical device by means of a tunable source.

6. The method of claim 5 where adjusting the optical length of the cavity of the optical device to maintain stable operation of the optical device comprises dithering the wavelength of the tunable source to maintain stable operation.

7. The method of claim 1 where adjusting the optical length of the cavity of the optical device to maintain stable operation of the optical device comprises adjusting the physical length of the cavity to maintain stable operation.

8. The method of claim 2 where introducing a seed beam into the cavity of the optical device outside of the cavity of the optical device comprises introducing a seed beam into the cavity of the optical device by means of a polarizer in front of the cavity of the optical device.

9. The method of claim 1 where generating a feedback signal from the output of the optical device comprises:
detecting signals associated with the envelope of the optical pulses produced by the optical device;
generating independent signals for the pulse intensity of the optical pulses and an RF modulation of the optical pulses from the detected signals;
generating the feedback signal to minimize the RF modulation of the optical pulses; and
matching the cavity length of the optical device to the seed signal by use of the feedback signal.

10. The method of claim 1 where generating a feedback signal from the output of the optical device comprises:
detecting signals associated with the envelope of the optical pulses produced by the optical device; and
matching the cavity length of the optical device to the seed signal by use of the detected signals.

11. The method of claim 7 where adjusting the physical length of the cavity to maintain stable operation comprises driving a piezo with the feedback signal and where generating a feedback signal from the output of the optical device comprises generating the feedback signal completely within a computer to observe an average piezo drive voltage to monitor when the piezo reaches its end range of motion and to restart a lock loop control to adjust the physical length of the cavity.

12. The method of claim 9 further comprising operating an optical shutter, which is only opened when stable seeding is achieved and is closed whenever a rise in the feedback signal is observed indicative of a rise in RF modulation.

13. The method of claim 1 further comprising a single longitudinal mode (SLM) optical parametric oscillator (OPO), which is pumped by the optical device.

14. An apparatus comprising:
an optical device having a cavity;
a seed laser generating a seed signal coupled to the optical device;
a feedback generator coupled to the output of the optical device for generating a feedback signal; and
means for adjusting the optical length of the cavity of the optical device coupled to the feedback generator to maintain stable operation of the optical device by means of the feedback signal.

15. The apparatus of claim 14 where the seed laser introduces a seed beam into the cavity of the optical device outside of the cavity of the optical device.

16. The apparatus of claim 14 where the optical device is a Q-switched pulsed laser.

17. The apparatus of claim 14 where the optical device is a Q-switched Nd:Yag laser.

18. The apparatus of claim 14 where the means for adjusting the optical length of the cavity is the seed laser which is tunable and whose wavelength is dithered to maintain stable operation.

19. The apparatus of claim 14 where the means for adjusting the optical length of the cavity of the optical device to maintain stable operation of the optical device comprises an electromechanical device for adjusting the physical length of the cavity to maintain stable operation.

20. The apparatus of claim 19 where the electromechanical device is a piezo actuator.

21. The apparatus of claim 15 further comprising a polarizer and where the seed laser introduces a seed beam into the cavity of the optical device outside of the cavity of the optical device by means of a polarizer in front of the cavity of the optical device, the optical device further comprising two compensating polarizers to substantially control reflected unpolarized light components.

22. The apparatus of claim 14 where the feedback generator comprises:
a detector of signals associated with the envelope of the optical pulses produced by the optical device;
a filter to generate independent signals for the pulse intensity of the optical pulses and an RF modulation of the optical pulses from the detected signals;
a feedback circuit to minimize the RF modulation of the optical pulses by matching the optical length of the cavity of the optical device to the seed signal by use of the feedback signal.

23. The apparatus of claim 14 where feedback generator comprises:
a detector of signals associated with the envelope of the optical pulses produced by the optical device; and
means for matching the cavity length of the optical device to the seed signal by use of the detected signals.

24. The apparatus of claim 14 where the means for adjusting the physical length of the cavity to maintain stable operation comprises a piezo and means for driving the piezo with the feedback signal and where feedback generator comprises signal a computer to determine an average piezo drive voltage to monitor when the piezo reaches its end range of motion and to restart a lock loop control to adjust the physical length of the cavity.

25. The apparatus of claim 22 further comprising operating an optical shutter, which is only opened when stable seeding is achieved and is closed whenever a rise in the feedback signal is observed indicative of a rise in RF modulation.

26. The apparatus of claim 14 where the optical device comprises a laser and further comprising a single longitudinal mode (SLM) optical parametric oscillator (OPO), which is pumped by the optical device.
